(19) United States
(12) Patent Application Publication
(10) Pub. No.: US 2015/0235487 A1
(43) Pub. Date: Aug. 20, 2015

(54) METHOD FOR ENABLING PEPS KEY TO OPERATE MULTIPLE VEHICLES

(71) Applicant: GM GLOBAL TECHNOLOGY OPERATIONS LLC, Detroit, MI (US)

(72) Inventors: DAVID T. PROEFKE, TROY, MI (US); RON Y. ASMAR, WEST BLOOMFIELD, MI (US); THOMAS E. UTTER, ROYAL OAK, MI (US); AARON P. CREGUER, FENTON, MI (US)

(21) Appl. No.: 14/622,145

(22) Filed: Feb. 13, 2015

Related U.S. Application Data
(60) Provisional application No. 61/940,283, filed on Feb. 14, 2014.

(51) Int. Cl. G07C 9/00

(52) U.S. Cl. CPC G07C 9/00007; G07C 9/00309; G07C 2009/00769

(57) ABSTRACT

Methods and apparatus are provided for configuration a single remote fob to be fully operational with different vehicles such as more than one vehicle within a vehicle fleet. In particular, the method and apparatus implements functional transmitter identification and synchronization to allow for dynamic authentication and configuration of the key fob with the last vehicle with which it was successfully passively authenticated.

### CROSS-REFERENCE TO RELATED APPLICATIONS

This application claims the benefit of U.S. Provisional Application No. 61/940,283 filed on Feb. 14, 2014. The entire disclosure of the above application is incorporated herein by reference.

### TECHNICAL FIELD

The present disclosure generally relates to vehicles having passive entry, passive start functionality, and more particularly relates to a method for configuring a passive entry, passive start key to operate one of a plurality of designated vehicles.

### BACKGROUND

Vehicles equipped with passive entry, passive start (PEPS) functionality are known in the art. With conventional PEPS systems one or two keyless fobs are associated with a given vehicle. Such PEPS vehicle systems generally include a body control module or BCM in the vehicle which is operable to lock and unlock the vehicle doors, release the truck latch, start-up and turn off the engine, honk the horn and other auxiliary vehicle functions. The body control module is also operable to communicate with the keyless fob to activate these vehicle functions.

These PEPS system communicates in one of two modes. In a first mode, a passive command is communicated between the keyless fob and the BCM as a low frequency or LF signal such that a passive entry is enabled simply by lifting the door handle or a passive start is enable by pushing a start button on the instrument panel. Such passive commands require the keyless fob to be in close proximity with the BCM. In a second mode, an active command is communicated between the keyless fob and the BCM as a radio frequency or RF signal such that an active lock/unlock or a remote engine start is enabled by pushing a button on the keyless fob. Such active commands may be carried out when the keyless fob is a substantial distance from the BCM.

For security reasons, the keyless fob and the BCM are statically configured and permanently assigned transceiver IDs which only enable one or two keyless fob to operate a specific vehicle. In other words, remote keyless functions, whether passive or active, are supported on one and only one vehicle. As such, the procedure of associating a new keyless fob with a particular vehicle is complicated and time-consuming. Likewise, PEPS-equipped vehicles in a commercial or police fleet require a specific keyless fob for each vehicle in the fleet. As such, a fleet driver is limited to use the specific fleet vehicle for his or her keyless fob and no fob variant exists that allows other vehicles within the fleet to be operated with that particular keyless fob.

Accordingly, it is desirable to develop a simple, quick and secure manner for associating a keyless fob with a BCM in a PEPS-equipped vehicle. In addition, it is desirable to allow a single PEPS keyless fob to be fully operational (passive commands, active commands and immobilizer functions) on more than one vehicle. Furthermore, other desirable features and characteristics of the present disclosure will become apparent from the subsequent detailed description and the appended claims, taken in conjunction with the accompanying drawings and this background.

### SUMMARY

A method is provided for dynamically configuring a PEPS system to be fully functional to issue passive and active commands upon passive authentication of the keyless fob with the BCM in a given vehicle selected from a fleet of vehicles.

In accordance with a disclosed method, a remote fob is authenticated for use with a body control module in at least one of a plurality of vehicles. In an embodiment a passive challenge function is initiated in a first vehicle selected from the plurality of vehicles. A vehicle identifier is issued from the body control module of the first vehicle to the remote fob in response to the passive challenge function. A functional transmitter identifier is issued from the remote fob to the body control module of the first vehicle in response to the remote fob receiving the vehicle identifier. The functional transmitter identifier is generated using the vehicle identifier and a stored transmitter identifier of the remote fob. The functional transmitter identifier is compared with at least one authenticated identifier stored in the body control module of the first vehicle. Radio frequency communication is enable between the body control module of the first vehicle and the remote fob when the functional transmitter identifier matches the at least one authenticated identifier. A wakeup command may be exchanged between a body control module in the first vehicle and the remote fob prior to issuing the vehicle identification from the body control module.

The remote fob may be authenticated for use with a body control module in a second vehicle from the plurality of vehicles. A second passive challenge function is initiated in a second vehicle selected from the plurality of vehicles. A vehicle identifier is issued from the body control module of the second vehicle to the remote fob in response to the passive challenge function. A functional transmitter identifier is issued from the remote fob to the body control module of the second vehicle in response to the remote fob receiving the vehicle identifier, wherein the functional transmitter identifier is generated using the vehicle identifier and a stored transmitter identifier of the remote fob. The functional transmitter identifier is compared with at least one authenticated identifier stored in the body control module of the second vehicle. Radio frequency communication is enable between the body control module of the second vehicle and the remote fob when the functional transmitter identifier matches the at least one authenticated identifier.

A PEPS system is also provided with dynamic configuration of a remote fob with a BCM in a given vehicle selected from a fleet of vehicles upon passive authentication of the system components. In accordance with a disclosed system, a remote fob includes circuitry configured to receive a vehicle identifier issued from the body control module of a first vehicle in response to a passive challenge function and issue a functional transmitter identifier to the body control module of the first vehicle. The functional transmitter identifier is generated using the vehicle identifier and a stored transmitter identifier of the remote fob. The functional transmitter identifier is compared with at least one authenticated identifier stored in the body control module of the first vehicle, and radio frequency communication is enable between the body control module of the first vehicle and the remote fob when the functional transmitter identifier matches the at least one authenticated identifier.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The present invention will hereinafter be described in conjunction with the following drawing figures, wherein like numerals denote like elements, and

FIG. 1 is a block schematic showing a PEPS system having a BCM and a set of keyless fobs;

FIG. 2 illustrates a vehicle fleet which may be authenticated to one of several keyless fobs;

FIG. 3 is a schematic illustration showing authentication of a keyless fob with a fleet vehicle; and

FIG. 4 is a flowchart showing an authentication process for a keyless fob with a fleet vehicle.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

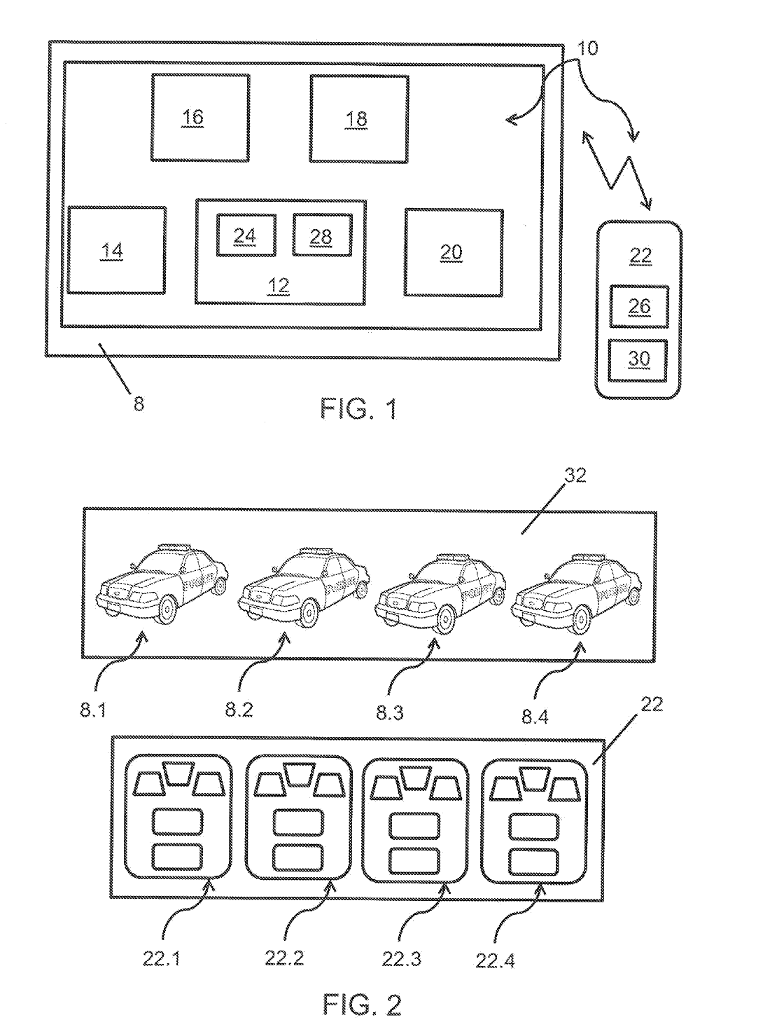

With reference FIG. 1, a vehicle 8 having a passive entry, passive start (PEPS) system 10 is schematically shown to include a body control module or BCM 12 that is operable to a door lock function 14 for locking and unlocking the vehicle doors, a trunk release function 16 for unlatching the truck lock, an engine start function 18 for starting the engine, and a horn function 20 for honking the horn. The BCM 12 may be configured to operate other auxiliary vehicle functions, e.g., seat heaters, vehicle lights, seat position, etc. The PEPS system 10 and in particular the BCM 12 is operable to wirelessly communicate with a keyless fob 22 for activating certain vehicle functions. Both the BCM 12 and the keyless fob 22 have data memory—BMC memory 24 and fob memory 26 respectively—which are used to store system identification information and synchronization information for enabling PEPS system functionality.

The BCM 12 includes circuitry 28 which is capable of wirelessly communicating with circuitry 30 in the keyless fob 22. Circuitry 28, 30 are conventional for current PEPS systems and capable of communicating in at least two modes. In a first passive mode, a passive command is communicated between the BCM 12 and the keyless fob 22 as a low frequency or LF signal. As used herein an LF signal is generally known in the art to be a data signal having a carrier frequency in the range of 30-300 kHz and typically on the order of about 125 kHz. Passive commands require the keyless fob 22 to be in close proximity with the BCM 12. In response to a passive challenge the BCM 12 interrogates or polls the area immediately around the vehicle using the LF signal to detect the keyless fob 22. When the keyless fob 22 receives and authenticates the polling signal, the key fob 22 will transmit a passive command signal to the BCM 12 for performing a particular function. Typically, passive challenges include a passive entry command for unlocking a door that is enabled by lifting the door handle, a passive trunk release that is enabled by pushing a trunk release button or a passive start command for starting the engine when a start button on the instrument panel is push.

In a second active mode, an active command is communicated between the keyless fob 22 and the BCM 12 as a radio frequency or RF signal. As used herein an RF signal is generally known in the art to be a data signal having a carrier frequency in the range of 300-500 MHz. Active commands are issued in response to pushing a button on the keyless fob 22. Typically, the active commands include an active lock command for locking a door, an active unlock command for unlocking the door, an active remote start command for starting the engine, an active trunk release command for opening the trunk and an alert command for repeatedly honking the horn. Because the active commands are issued as an RF signal, they may be carried out when the keyless fob 22 is a substantial distance from the BCM 12.

FIG. 2 illustrates a plurality or fleet of vehicles 8.1, 8.2, 8.3, 8.4, each having a PEPS system 10 as described above. A plurality of keyless fobs 22.1, 22.2, 22.3 22.4, 2 may be dynamically configured with the BCM 12 of a given vehicle 8 selected from a fleet of vehicles 8.1, 8.2, 8.3, 8.4, using passive authentication of the PEPS system 10. The BCM 12 in each of the vehicles 8.1, 8.2, 8.3, 8.4 is calibrated with a unique vehicle ID or VID in BCM memory 24, and each keyless fob 22.1, 22.2, 22.3, 22.4 is calibrated with a unique stored transmitter ID or STID in fob memory 26. The VID and STID are used to dynamically configure a functional transmitter ID or UID in the keyless fob 22 which corresponds with a UID calibrated in the BCM 12 of every fleet vehicle. In this way, conventional remote keyless entry functionality can be securely performed on the BCM 12 in last vehicle with which the keyless fob 22 was successfully authenticated.

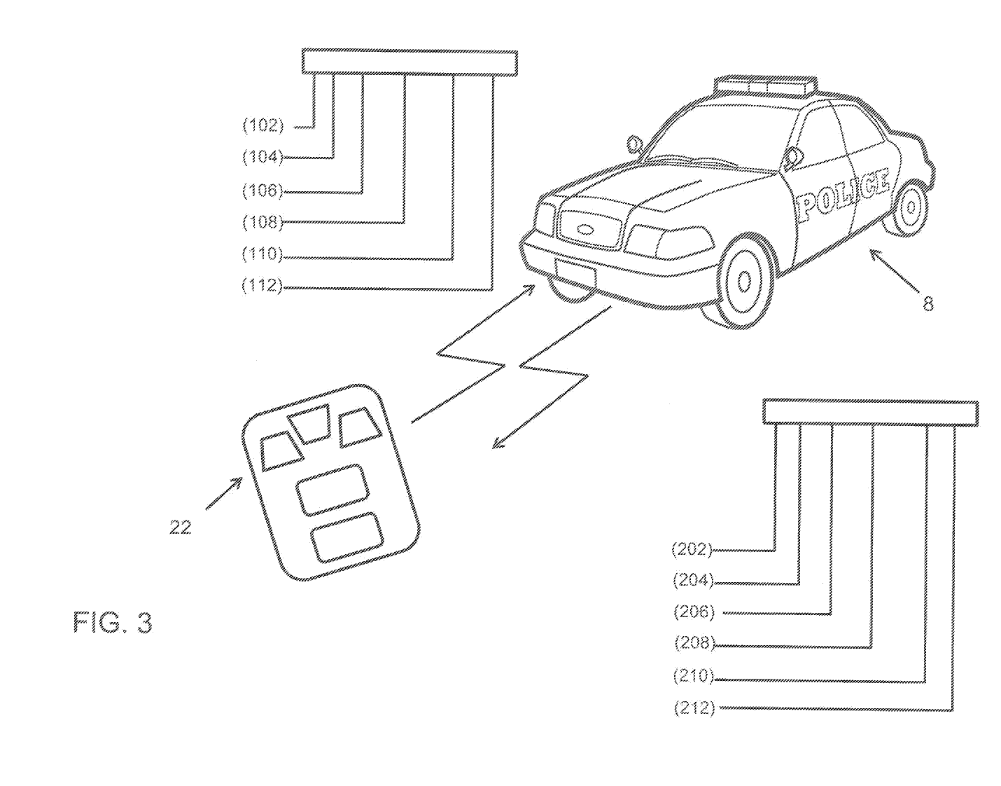

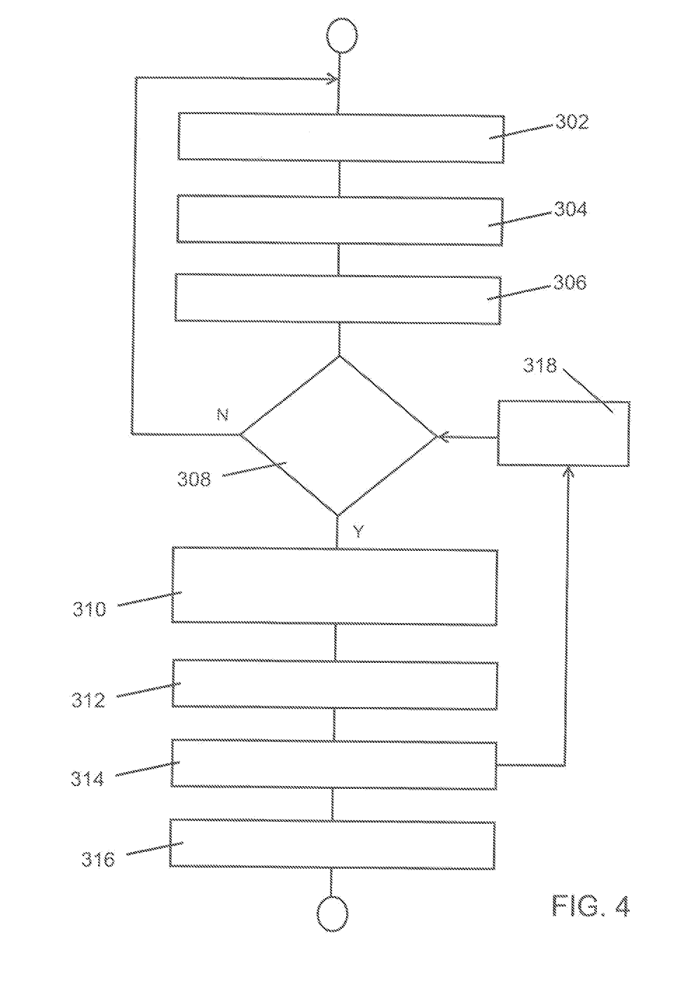

With reference now to FIGS. 3 and 4, the passive authentication process will now be described in which an attempted operation of the PEPS system 10 in the passive mode executes an authentication process for pairing a BCM 12 with a keyless fob 22. To initiate the process, an LF wakeup command is exchanged from the BCM 12 of vehicle 8 to keyless fob 22 as represented at block 302. As presently preferred, the LF wakeup command for fleet applications is a 4 byte command that includes a 2 byte wakeup pattern and a 2 byte VID referred to as a 2+2 fleet pattern. The 2 byte wakeup pattern may be a generic vehicle wakeup pattern or a unique fleet wakeup pattern configured for a specific set of vehicles. As presently preferred, the keyless fob 22 will also have a fleet enable flag stored in fob memory 26 which is used to determine when a 4 byte conventional wakeup pattern (i.e., for non-fleet vehicles) is enabled and when a 2+2 fleet pattern described above is enabled.

In response to a passive challenge (i.e., passive commands received by the BCM 12), the BCM 12 issues its VID to the fob 22 as shown at block 304. The fob 22 generates and returns a functional transmitter ID or UID to the BCM 12 as shown at block 306. The UID is generated based on the VID from the BCM 12, STID of the fob 22 and a passive command code. The BCM 12 compares the UID with a list of authenticated UIDs stored in BCM memory 24 as shown at block 308. If the UID does not match one of the authenticated UIDs, then the keyless fob 22 has not been properly configured for the fleet vehicle 8 and the fob 22 is not authorized to operate the PEPS system 10. The PEPS system control returns to execute the LF wakeup command at block 302.

If the UID matches one of the authenticated UIDs, then the keyless fob 22 has been properly authenticated for the fleet vehicle 8 and the fob 22 is authorized to operate the PEPS system 10 of that vehicle as shown at block 310. Upon authentication of the keyless fob 22, the circuitry 28 in the PEPS 10 is updated for responding to active commands from the circuitry 30 in keyless fob 22. The VID is also stored in the fob memory 26 at block 310 for allowing the keyless fob 22 to track which vehicle it was last used for passive challenges and for enabling the active command functionality between specific BCM-keyless fob combinations. The fob memory 26 has a user data block for storing various vehicle data such as tracking of the last vehicle accessed by the UID, vehicle odometer, etc. As presently preferred, the fob memory 26 is enabled to store such user data for the last two fleet vehicles used.

At this point, the UID is used to enable the authenticated keyless fob 22 for issuing active commands to the authenticated BCM 12 based on button pushes on the keyless fob 22 at block 312. Subsequently passive challenges may be used to execute a passive command at block 314 and to dynamically configure a functional synchronization counter as shown at block 316 and further described below. The BCM memory 24 has a transmitter data block for storing the transmitter ID for several (e.g. the last eight) passively-authenticated keyless fobs 22. The BCM memory 24 also has a sync_counter data block for storing the synchronization counter for the last eight transmitter IDs.

With specific reference to FIG. 3, data structure 100 represents the data issued from the remote fob 22 to the vehicle 8 and includes a wakeup byte 102, a header byte 104, response value 106, a functional transmitter ID 108, miscellaneous data 110 (such as a battery status for the fob 22) and a checksum byte 112. Similarly, data structure 200 represents the data issued from the BCM 10 to the fob 22 and includes a wakeup byte 202, a wakeup pattern 204 (such as a generic 4 byte pattern or a 2+2 fleet enabled pattern), a header/command byte 206, a zone detect byte 208, a random challenge 210 and the remainder of the vehicle ID 212.

Additional functions may be implemented when the fleet enable flag is set for the PEPS system 10. For example, when a new passive challenge for a driver door function—door unlock, door lock, door opening/ajar—the UID in the fob 22 may reset to be 2 bytes of its unique ID (STID) and 2 byte of the VID at block 318. In this way the keyless fob 22 can be authenticated to the vehicle with which the “driver” is interacting. As presently preferred, the passive challenge reset may be limited to opening the driver side door to prevent modifying the expected operation of a “passenger” with a separate fleet-enabled keyless fob. When the keyless fob 22 receives a new passive challenge for a driver door function, the current functional synchronization counter is modified to equal a random challenge value received. The challenge value is then used to provide a method for authenticating passive operation as well as synchronizing vehicle 8 and fob 22 without adding additional data bytes in transmission or requiring a secondary communication event.

When the BCM 12 receives a response from a new passive challenge for a driver door function, it will compare the received UID with the valid Transmitter IDs stored within memory. If the Transmitter ID is not already present, it will store the received UID into the least recently used ID memory location and update the RF receiver associated with circuitry 28 as needed at block 310. Storage of the UID is required to identify which transmitters are valid for actively controlling the vehicle and to maintain smart filtering of RF receiver.

When the BCM 12 receives a response from a new passive challenge for a driver door function, it will compare the received UID with the valid Transmitter IDs stored within memory 24. If the Transmitter ID is not already present, it will store the transmitted challenge value as the Synchronization Counter for the applicable Transmitter ID. This allows for automatic synch counter update without additional data transmissions between the BCM 12 and the keyless fob 22.

As presently preferred, the calibration programmed into keyless fob 22 may include a fleet function flag which is used to determine whether the keyless fob 22 will actively work with only one vehicle or dynamically update to operate the last passively accessed vehicle. This function allows for single keyless fob design to be used in multiple ways—namely for fleet users, for single end users, and for replacement of the original fobs, thereby reducing warranty due to customer confusion with dynamic mode.

An encrypted fleet secret key may also be calibrated into the BCM 12 such that the decrypted value can be programmed into the keyless fob 22 during key learning. This functionality allows for unique secret keys for police fleets versus non-police fleet or between different law enforcement fleets as needed.

A fleet enable function may also be supported as a calibration in the BCM 12 which, during key learning, identifies whether BCM Random Secret Keys and Wakeup Patterns which are to be programmed into the keyless fob 22 or if fleet secret key, fleet wakeup pattern, and fleet enable will be programmed into the keyless fob 22. Once programmed into the keyless fob 22, the fleet enable flag will be used to determine 2+2 byte or 4 byte wakeup pattern and functional transmitter ID definition. This functionality also reduces part numbers and keyless fob complexity by allowing common keyless fobs to be used as either fleet or master keys.

A single “Master Secret Key” may be used for programming of OEM specific keyless fobs with additional unique, random secret keys allows keys to be reused/reprogrammed to additional or different vehicles in the future. This functionality reduces the impact of keys inadvertently swapped at the plant or subsequent vehicle service procedures.

Lastly, user data such as odometer, VIN, key number, programming event data, etc. are cipher written to the keyless fob memory 28 with value encryption. Software within the keyless fob 22 will, upon writing, decrypt the data and store the plain read version of the data within memory configured as Plain Read/Denied Write. Additional keyless fob software delaying between decrypt cycles may also be used for maintaining security of user data while allowing use of a common OEM Master Secret Key in all keys.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A method for authenticating a remote fob with at least one of a plurality of vehicles comprising:
initiating a passive challenge function in a first vehicle selected from the plurality of vehicles;
issuing a vehicle identifier from the body control module of the first vehicle to the remote fob in response to the passive challenge function;
issuing a functional transmitter identifier from the remote fob to the body control module of the first vehicle in response to the remote fob receiving the vehicle identifier, wherein the functional transmitter identifier is generated using the vehicle identifier and a stored transmitter identifier of the remote fob;
comparing the functional transmitter identifier with at least one authenticated identifier stored in the body control module of the first vehicle; and
enabling radio frequency communication between the body control module of the first vehicle and the remote fob when the functional transmitter identifier matches the at least one authenticated identifier.

2. The method of claim 1 further comprising exchanging a wakeup command between a body control module in the first vehicle and the remote fob prior to issuing the vehicle identification from the body control module.

3. The method of claim 1 further comprises setting a fleet enable flag in the remote fob to enable generation of the functional transmitter identification in response to the remote fob receiving the vehicle identifier.

4. The method of claim 3 further comprises clearing the fleet enable flag in the remote fob to disable generation of the functional transmitter identification.

5. The method of claim 1 further comprising issuing the vehicle identifier from the body control module of the first vehicle to the remote fob in response to the passive challenge function for a driver's side door function.

6. The method of claim 5 further comprising modifying a synchronization counter stored in the body control module in response to the passive challenge function.

7. The method of claim 1 further comprising storing user data issued from the body control module to a fob memory in the remote fob.

8. The method of claim 7 wherein the user data comprises at least one of an odometer reading from the first vehicle, a vehicle identification number, a key number, and programming event data.

9. The method of claim 1 further comprising calibrating an encrypted fleet secret key into the body control module and programing a decrypted value of the fleet secret key into the remote fob, wherein a unique fleet secret key is provided for the plurality of vehicles.

10. The method of claim 1 further comprises:
initiating a second passive challenge function in a second vehicle selected from the plurality of vehicles;
issuing a vehicle identifier from the body control module of the second vehicle to the remote fob in response to the passive challenge function;
issuing a functional transmitter identifier from the remote fob to the body control module of the second vehicle in response to the remote fob receiving the vehicle identifier, wherein the functional transmitter identifier is generated using the vehicle identifier and a stored transmitter identifier of the remote fob;
comparing the functional transmitter identifier with at least one authenticated identifier stored in the body control module of the second vehicle; and
enabling radio frequency communication between the body control module of the second vehicle and the remote fob when the functional transmitter identifier matches the at least one authenticated identifier.

11. A passive entry, passive start system for at least one of a plurality of vehicles, each vehicle having a body control module operable to execute at least one vehicle function in response to a passive challenge, the system comprising:
a remote fob having circuitry configured to receive a vehicle identifier issued from the body control module of a first vehicle in response to a passive challenge function and issue a functional transmitter identifier to the body control module of the first vehicle, wherein the functional transmitter identifier is generated using the vehicle identifier and a stored transmitter identifier of the remote fob;
wherein the functional transmitter identifier is compared with at least one authenticated identifier stored in the body control module of the first vehicle, and radio frequency communication is enable between the body control module of the first vehicle and the remote fob when the functional transmitter identifier matches the at least one authenticated identifier.

12. The passive entry, passive start system of claim 11 wherein the remote fob further comprises memory for storing a fleet enable flag in the remote fob, wherein the functional transmitter identification is generated in response to the remote fob receiving the vehicle identifier when the fleet enable flag is set.

13. The passive entry, passive start system of claim 11 wherein the remote fob further comprises memory for storing user data issued from the body control module to a fob memory in the remote fob.

14. The passive entry, passive start system of claim 13 wherein the user data comprises at least one of an odometer reading from the first vehicle, a vehicle identification number, a key number, and programming event data.

15. The passive entry, passive start system of claim 11 wherein the remote fob further comprises memory for storing a decrypted value of a fleet secret key, wherein a unique fleet secret key is provided for the plurality of vehicles.

16. The passive entry, passive start system of claim 11 wherein the circuitry in remote fob is further configured to receive a vehicle identifier from the body control module of a second vehicle in response to the passive challenge function and a functional transmitter identifier to the body control module of the second vehicle, wherein the functional transmitter identifier is generated using the vehicle identifier and a stored transmitter identifier of the remote fob;
wherein the functional transmitter identifier is compared with at least one authenticated identifier stored in the body control module of the second vehicle, and radio frequency communication is enabled between the body control module of the second vehicle and the remote fob when the functional transmitter identifier matches the at least one authenticated identifier.

17. A passive entry, passive start system including a remote fob operable with a plurality of vehicles to execute at least one active command, each of the plurality of vehicles having a body control module operable to execute at least one vehicle function in response to a passive challenge, the body control module comprising circuitry configured to issue a vehicle identifier from the body control module of a first vehicle to the remote fob in response to a passive challenge function and receive a a functional transmitter identifier from the remote fob, wherein the functional transmitter identifier is generated using the vehicle identifier and a stored transmitter identifier of the remote fob, compared with at least one authenticated identifier stored in the body control module of the first vehicle, a radio frequency communication is enable between the body control module of the first vehicle and the remote fob when the functional transmitter identifier matches the at least one authenticated identifier.

18. The passive entry, passive start system of claim 17 wherein the circuitry is configured to issue the vehicle identifier from the body control module of the first vehicle in response to the passive challenge function for a driver's side door function.

19. The passive entry, passive start system of claim 11 wherein circuitry of the body control module is configured to issue user data for storing in fob memory in the remote fob.

20. The passive entry, passive start system of claim 19 wherein the user data comprises at least one of an odometer reading from the first vehicle, a vehicle identification number, a key number, and programming event data.
